(19) United States
(12) Patent Application Publication
(10) Pub. No.: US 2023/0347492 A1
(43) Pub. Date: Nov. 2, 2023

(54) HYDRAULIC TORQUE WRENCH

(71) Applicant: ENERPAC TOOL GROUP CORP., Menomonee Falls, WI (US)

(72) Inventors: Robin SHAW, Whitley Bay (GB); Andrew DUMELOW, North Shields (GB)

(73) Assignee: ENERPAC TOOL GROUP CORP., Menomonee Falls, WI (US)

(21) Appl. No.: 18/026,760

(22) PCT Filed: Oct. 15, 2021
(86) PCT No.: PCT/US2021/055265

§ 371 Date: Mar. 16, 2023

Related U.S. Application Data
(60) Provisional application No. 63/092,079, filed on Oct. 15, 2020.

(51) Int. Cl. B25B 21/00; B25F 5/00

(52) U.S. Cl. CPC B25F 5/005; B25B 21/005

(57) ABSTRACT

A hydraulic torque wrench and a method of operating a hydraulic torque wrench. The wrench may be operable to apply torque to a workpiece. The wrench may include a housing; a drive system; a driver rotatably driven by the drive system and configured to selectively engage the workpiece; and a gripping mechanism including an end configured to selectively engage the workpiece, the gripping mechanism being movable between a first position, in which the end engages a surface of the workpiece, and a second position, in which the end is disengaged from the workpiece.

### RELATED APPLICATION

The present application claims the benefit of U.S. Pat. Application No. 63/092,079, filed Oct. 15, 2020, the entire contents of which is hereby incorporated by reference.

### FIELD

The present disclosure relates to industrial tools and, particularly, to hydraulic torque wrenches.

### SUMMARY

Industrial tools, such as hydraulic torque wrenches, use pressurized fluid to apply large torques to a workpiece (e.g., fastener, nut, etc.). In particular, application of pressurized fluid to a piston drives a socket to rotate in a first direction.

In one independent aspect, a hydraulic torque wrench operable to apply torque to a workpiece may be provided. The wrench may generally include a housing; a drive system; a driver driven by the drive system and configured to engage the workpiece; and a gripping mechanism operable to selectively retain the workpiece relative to the driver, the gripping mechanism including an end configured to selectively engage the workpiece, the gripping mechanism movable between a first position, in which the end engages a surface of the workpiece to retain the workpiece relative to the driver, and a second position, in which the end is disengaged the workpiece.

In another independent aspect, a hydraulic torque wrench may generally include a housing; a drive system; a driver driven by the drive system and configured to engage the workpiece; and a gripping mechanism operable to selectively retain the workpiece relative to the driver, the gripping mechanism being coupled to the driver and including a pin having an end selectively engageable with the workpiece, the pin being movable between a first position, in which the end engages a surface of the workpiece to retain the workpiece relative to the driver, and a second position, in which the end is disengaged from the workpiece.

In yet another independent aspect, a method of operating a hydraulic torque wrench operable to apply torque to a workpiece may be provided. The wrench may include a housing, a drive system, and a driver rotatably driven by the drive system and configured to selectively engage the workpiece. The method may generally include selectively engaging an end of a gripping mechanism with the workpiece, selectively engaging including moving the gripping mechanism between a first position, in which the end engages a surface of the workpiece to retain the workpiece relative to the driver, and a second position, in which the end is disengaged from the workpiece.

In a further independent aspect, a method may generally selectively engaging an end of a pin of a gripping mechanism with a workpiece, selectively engaging including moving the pin between a first position, in which the end engages a surface of the workpiece to retain the workpiece relative to a driver, and a second position, in which the end is disengaged from the workpiece

Other independent aspects may become apparent by consideration of the detailed description, claims, and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a perspective view of a hydraulic torque wrench.

FIG. 2 is an enlarged perspective view of a driver of a hydraulic torque wrench, illustrating a gripping mechanism.

FIG. 3 is an exploded view of the driver of the wrench of FIG. 2.

FIG. 4 is a side view of the driver of the wrench of FIG. 2, illustrating the gripping mechanism.

FIG. 5 is a side view of the driver of the wrench of FIG. 2, illustrating the gripping mechanism in a disengaged state.

FIG. 6 is another side view of the driver of the wrench of FIG. 2, illustrating the gripping mechanism moving from the disengaged state.

FIG. 7 is a side view of the driver of the wrench of FIG. 2, illustrating the gripping mechanism in an engaged state.

FIG. 8 is another side view of the driver of the wrench of FIG. 2, with the gripping mechanism in the engaged state and illustrating movement of the pins.

FIG. 9 is a side view of the driver of the wrench of FIG. 2, illustrating the gripping mechanism in the disengaged state.

### DETAILED DESCRIPTION

Before any independent embodiments are explained in detail, it is to be understood that the disclosure is not limited in its application to the details of construction and the arrangement of components set forth in the following description or illustrated in the following drawings. The disclosure is capable of other independent embodiments and of being practiced or of being carried out in various ways. Also, it is to be understood that the phraseology and terminology used herein is for the purpose of description and should not be regarded as limiting.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

Relative terminology, such as, for example, “about”, “approximately”, “substantially”, etc., used in connection with a quantity or condition would be understood by those of ordinary skill to be inclusive of the stated value and has the meaning dictated by the context (for example, the term includes at least the degree of error associated with the measurement of, tolerances (e.g., manufacturing, assembly, use, etc.) associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10% or more) of an indicated value.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

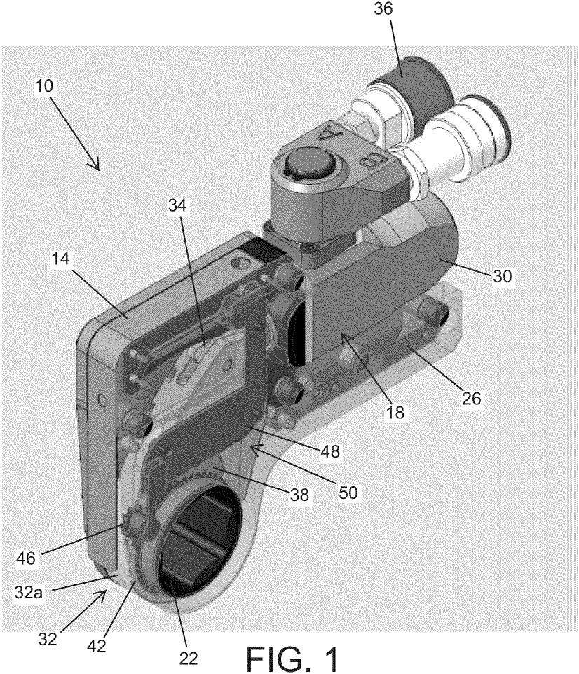

FIG. 1 illustrates an industrial tool, such as a hydraulic torque wrench 10 for applying torque to a workpiece or fastener (e.g., nut, bolt, etc. (not shown)). The illustrated wrench 10 includes a cassette or housing 14 supporting a drive element, and the housing 14 is connectable to a drive unit 18 for actuating the drive element. In the illustrated construction, the drive element is a socket 22 for receiving a portion of the workpiece; in other constructions (not shown), the drive element may include a drive shaft or other suitable drive element.

The wrench 10 also includes a reaction portion or reaction arm 26. In the illustrated construction, the reaction arm 26 is integrally formed with the housing 14. In some constructions (not shown), the reaction arm 26 is removably attached to the housing 14. The housing 14 may be constructed of metal (e.g., steel), a durable and lightweight plastic material, a combination thereof, etc.

The drive unit 18 includes a fluid actuator 30 and a working end 34. The working end 34 is driven by the fluid actuator 30 and is coupled to a lever arm 32 supported on the housing 14.

In the illustrated construction, the fluid actuator 30 includes a cylinder supporting at least one piston. Movement of the piston drives the working end 34 between an extended position and a retracted position. The fluid actuator 30 is in fluid communication with an external source of pressurized fluid (such as a pump (not shown)) via one or more fluid hoses 36. In some constructions, the hose(s) is connected to the drive unit 18 and placed in fluid communication with the fluid actuator 30 by a quick disconnect coupler, although other types of connections are possible. Pressurized fluid supplied to the fluid actuator 30 drives movement of the piston, which, in turn, drives movement of the working end 34 (by a rod coupled between the piston and the working end 34).

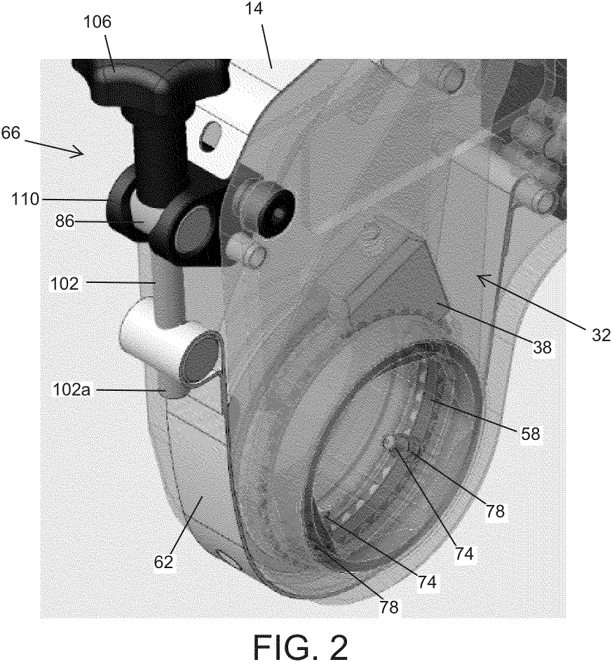

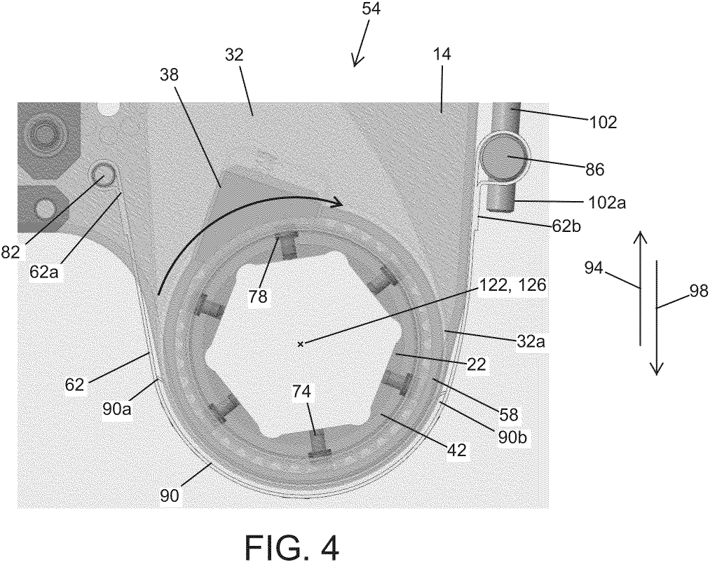

As shown in FIGS. 1-2, the working end 34 is coupled to the lever arm 32, which, in turn, engages a sprocket 42 by at least one pawl 38. In the illustrated constructions, the sprocket 42 is positioned adjacent an outer surface of the socket 22, and rotation of the sprocket 42 drives the socket 22 to rotate in a first direction (e.g., clockwise as illustrated in FIG. 4). Rotation of the socket 22 transmits torque to a workpiece, such as a fastener.

When hydraulic pressure is applied to the fluid actuator 30 to extend the working end 34, the lever arm 32 is driven to pivot in the first direction. The pawl 38 engages the sprocket 42, thereby causing the sprocket 42 to rotate. Specifically, teeth of the pawl 38 engage corresponding teeth of the sprocket 42 to rotate the sprocket 42 and, as a result, also rotates the workpiece engaged by the socket 22. The lever arm 32 pivots through an angle of rotation as the fluid actuator 30 extends to its maximum stroke length. As the fluid actuator 30 retracts, the teeth of the pawl 38 slip relative to the sprocket 42, thereby allowing the lever arm 32 to ratchet relative to the socket 22.

In the illustrated construction, a workpiece or fastener may be tightened by positioning the fastener within the socket 22 such that rotation of the socket 22 in the first direction applies torque in a direction to tighten the fastener. Alternatively, to loosen the fastener, the wrench 10 can be flipped to engage the fastener from the other side of the socket 22, which would still be rotated in the first direction.

With reference to FIGS. 2-9, the wrench 10 additionally includes a gripping mechanism 54 for maintaining a position of the fastener relative to the socket 22, in other words, to retain the fastener relative to the socket 22. The gripping mechanism 54 includes a retaining ring 58, an elongated tension member or belt 62, and an actuator 66.

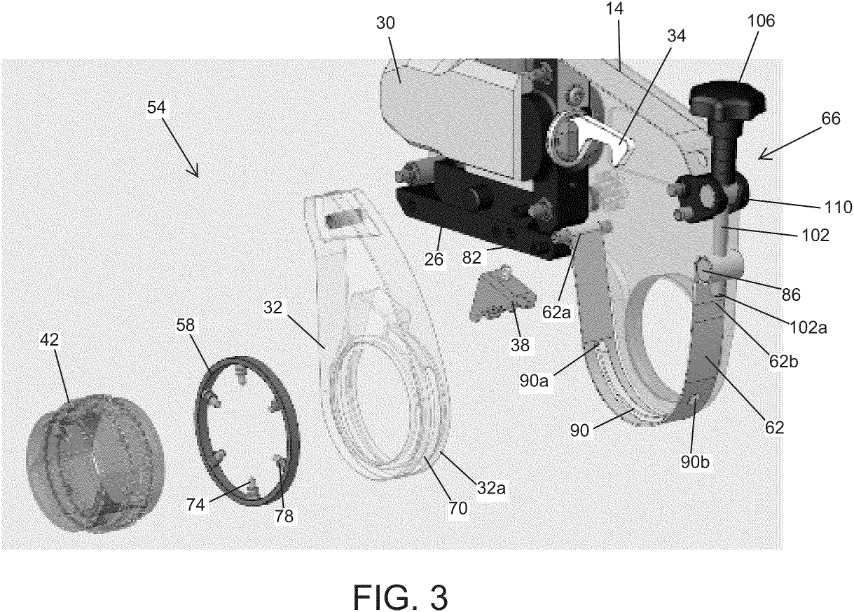

In the illustrated construction, the retaining ring 58 is a cylindrical ring positioned between the sprocket 42 and the lever arm 32. More specifically, the retaining ring 58 extends around the periphery of the sprocket 42 and fits within a slot 70 (FIG. 3) positioned on the lever arm 32. The retaining ring 58 rotates with the socket 22.

As shown in FIGS. 3-4, pins 74 are supported on and circumferentially spaced around the ring 58, such that the pins 74 protrude inwardly from the ring 58. In the illustrated construction, each pin 74 is biased (e.g., by a spring 78 extending around a body of the pin 74) in a radially outward direction. More specifically, each pin 74 is movable between a resting position, in which the pin 74 is in a radially outer position against the retaining ring 58, and extended position, in which the pin 74 is moved against the bias of the springs 78 to protrude inwardly through a corresponding aperture on an outer surface of the socket 22.

In the illustrated constructions, the retaining ring 58 supports six pins 74, and the illustrated pins 74 are constructed of a hardened steel material. However, in other constructions, the retaining ring 58 may include fewer or more pins 74. In other constructions, the pins 74 may be constructed of another material.

The illustrated belt 62 is an elongated band, or strap, positioned along an outer periphery of the ring 58. In the illustrated construction, one end of the band 62 is secured to the housing 14 while the other end of the band 62 is movable relative to the housing 14. For example, as shown, a first end 62a of the band 62 is coupled to a first post 82 on an inner surface of the housing 14 adjacent the reaction arm 26, and a second end 62b of the band 62 is coupled to a second post 86 on an outer surface of the housing 14. The posts 82, 86 are positioned on opposite sides of the socket 22.

The belt 62 extends along a portion of the circumference of a cylindrical portion 32a of the lever arm 32. Also, in the illustrated construction, a protrusion 90 is positioned on a portion of an inner surface of the belt 62. The protrusion 90 is sized to fit within the slot 70, so as to urge the retaining ring 58 in an upward direction 94.

In the illustrated construction, the actuator 66 includes a hand screw with a threaded shaft 102 and a handle 106 (FIG. 3). The hand screw 66 is coupled to the outer surface of the housing 14 via a coupler 110. The shaft 102 extends substantially parallel to the outer surface of the housing 14, and an end 102a of the shaft 102 extends through the second post 86.

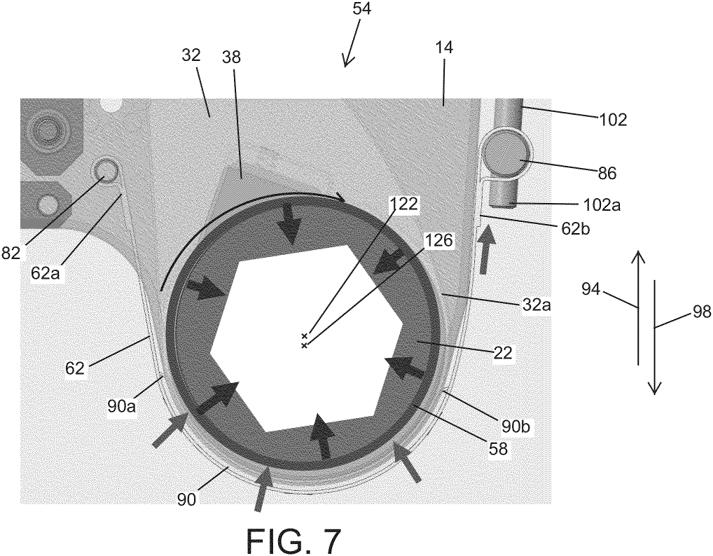

When a user threads the shaft 102 relative to the second post 86 (e.g., by rotating the handle 106 clockwise), the post 86 moves in the upward direction 94, and tension in the belt 62 is increased. As a result, at least a portion of the ring 58 is moved toward a center 122 of the socket 22 (see FIG. 7). Conversely, when the user moves the handle 106 to unthread the shaft 102 relative to the second post 86 (e.g., by rotating the handle 106 counterclockwise), the post 86 moves in a downward direction 98, and the tension in the belt 62 is reduced. In some constructions, the actuator 66 may include a different type of actuator (e.g., an over-center latch, a toggle, etc.).

FIGS. 4-9 illustrate the process of actuating the gripping mechanism 54. FIG. 4 illustrates the gripping mechanism 54 in a non-engaged position. The retaining ring 58 is loosely positioned within a groove of the sprocket 42, such that there is minimal tension between the retaining ring 58 and the socket 22. The retaining ring 58 is positioned such that a center 122 of the retaining ring 58 is aligned with a center 126 of the socket 22. In this position, the socket 22 may be positioned around the fastener (not shown) to position the tool 10 for operation.

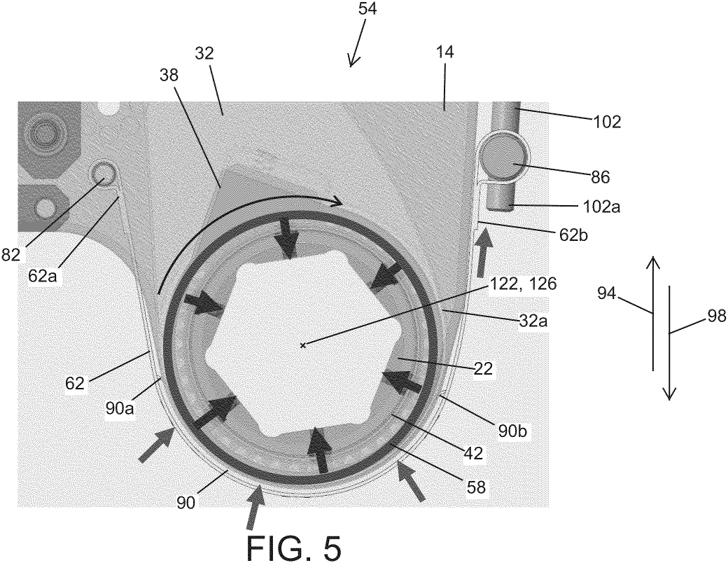

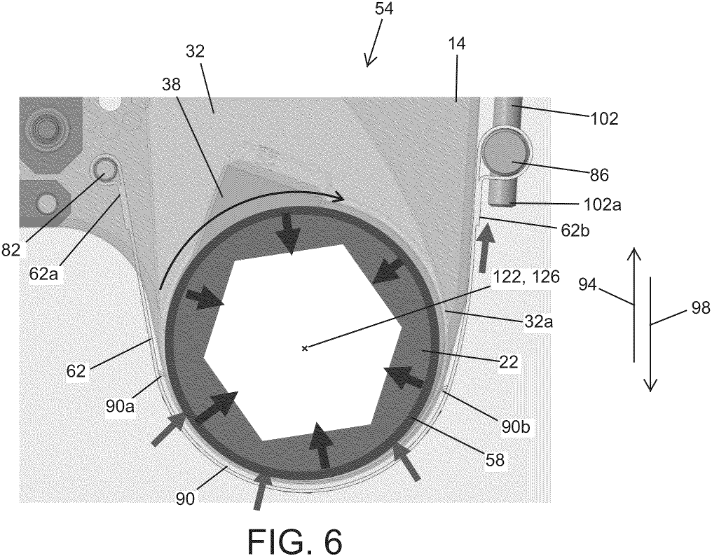

With reference to FIGS. 5-6, when the handle 106 is operated to increase tension in the belt 62, the protrusion 90 of the belt 62 presses against the outer periphery of the ring 58. The tension of the belt 62 overcomes the bias exerted by the springs 78 in an area of the ring 58 adjacent the protrusion 90. As a result, the pins 74 adjacent the protrusion 90 are pushed radially inwardly (e.g., upwardly as shown in the movement from FIG. 5 to FIG. 7).

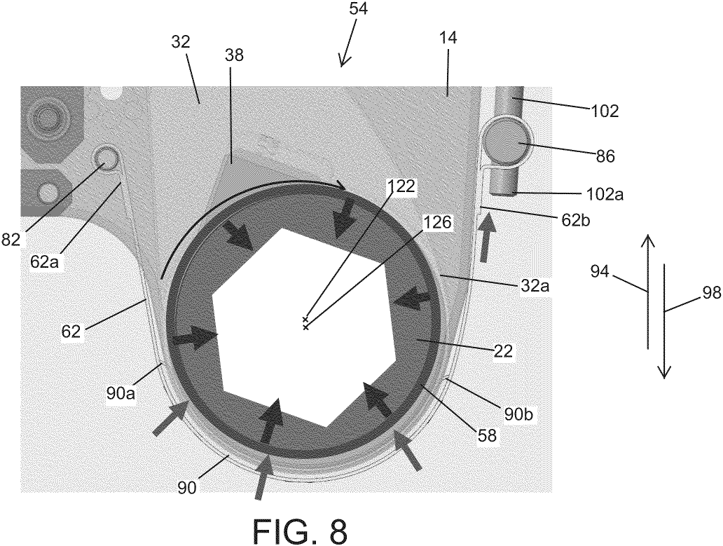

As the socket 22 rotates (e.g., as shown in the movement from FIG. 7 to FIG. 8), the other pins 74 are rotated to be positioned adjacent the protrusion 90 of the belt 62 and are therefore pushed radially inwardly. In the illustrated constructions, the gripping mechanism 54 is configured such that the protrusion 90 engages three pins 74 at one time. However, in other constructions (not shown), fewer or more pins 74 may be engaged by the protrusion 90 concurrently.

With reference to FIG. 7, as the handle 106 is operated to increase the tension in the belt 62, the retaining ring 58 moves such that the midpoint 122 of the retaining ring 58 moves away from a midpoint 126 of the socket 22. In the illustrated construction, the midpoint 122 of the retaining ring 58 is moved above the midpoint 126 of the socket 22. The tension of the belt 62 urges the pins 74 positioned along the portion of the retaining ring 58 in contact with the protrusion 90 of the belt 62 toward the extended position, such that the pins 74 are pushed against the surface of the fastener. The gripping force of the pins 74 against the surface of the fastener inhibits movement of the fastener (e.g., to prevent accidental removal of the fastener from the socket 22).

FIG. 8 illustrates movement of the pins 74 as the socket 22 is rotated. Hydraulic pressure is applied to the fluid actuator 30 to extend the lever arm 32, and the pawl 38 engages the sprocket 42, thereby causing the sprocket 42 and the socket 22 to rotate. The retaining ring 58 rotates with the socket 22, (e.g., in the clockwise direction in FIG. 8) while the belt 62 remains stationary.

As one of the pins 74 exits the region adjacent the tensioned belt 62 (e.g., moves past a first endpoint 90a of the protrusion 90 of the belt 62), the exiting pin 74 is biased by the spring 78 out of contact with the fastener. Concurrently, as another of the pins 74 enters the region adjacent the tensioned belt 62 (e.g., moves past a second endpoint 90b of the protrusion 90 of the belt 62), the tension of the belt 62 urges the entering pin 74 into the extended position and into engagement with the fastener. The pins 74 continue to move into and out of engagement with the fastener as the socket 22 continues to rotate. During operation of the wrench 10 in this position and rotation of the socket 22, the pins 74 selectively engage the fastener to retain the fastener in position relative to and to rotate with the socket 22.

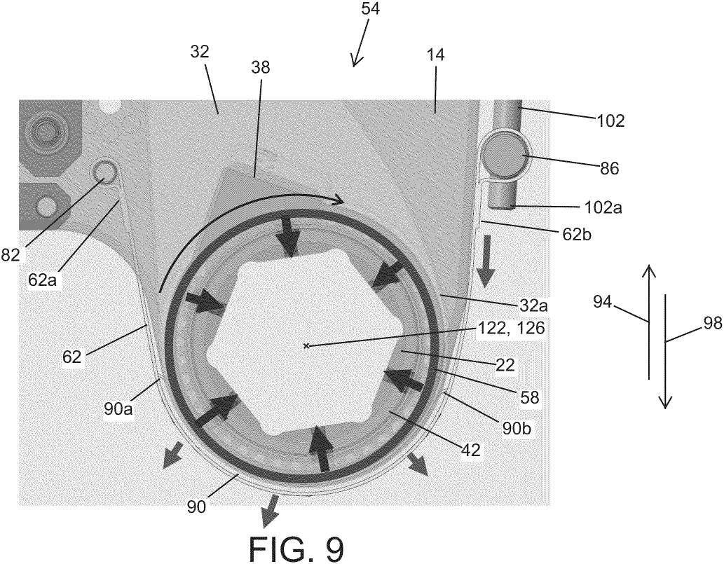

With reference to FIG. 9, a user may disengage the gripping mechanism 54 by rotating the handle 106 to reduce tension in the belt 62. In the illustrated construction, when the handle 106 is rotated to thread the shaft 102 in the downward direction 98, the tension exerted on the retaining ring 58 from the belt 62 is reduced, causing movement of the retaining ring 58. More specifically, the midpoint 122 of the retaining ring 58 moves toward the midpoint 126 of the socket 22. In some constructions, while the belt 62 is not tensioning the retaining ring 58, the retaining ring 58 is loosely positioned relative to the outer periphery of the socket 22. Each spring 78 biases the associated pin 74 out of contact with the surface of the fastener, allowing the user to remove the tool 10 from the fastener.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

One or more features and/or advantages of the invention may be set forth in the following claims:

What is claimed is:

1. A hydraulic torque wrench operable to apply torque to a workpiece, the wrench comprising:
a housing;
a drive system;
a driver rotatably driven by the drive system and configured to selectively engage the workpiece; and
a gripping mechanism operable to selectively retain the workpiece relative to the driver, the gripping mechanism including an end configured to selectively engage the workpiece, the gripping mechanism being movable between a first position, in which the end engages a surface of the workpiece to retain the workpiece relative to the driver, and a second position, in which the end is disengaged from the workpiece.

2. The wrench of claim 1, wherein the gripping mechanism includes a pin providing the end.

3. The wrench of claim 2, wherein the driver is rotatable about an axis, and wherein the pin is supported for movement about the axis, the pin moving between the first position and the second position during movement about the axis.

4. The wrench of claim 2, wherein the gripping mechanism includes a plurality of pins, each of the plurality of pins providing an end selectively engageable with the workpiece, each of the plurality of pins being movable between a first position, in which the end engages a surface of the workpiece to retain the workpiece relative to the driver, and a second position, in which the end is disengaged from the workpiece.

5. The wrench of claim 4, wherein the driver is rotatable about an axis, and wherein each of the plurality of pins is supported for movement about the axis, each of the plurality of pins moving between the first position and the second position during movement about the axis.

6. The wrench of claim 2, wherein the gripping mechanism includes a spring operable to bias the pin toward the second position.

7. The wrench of claim 1, wherein the driver includes a lever arm and a drive element, the drive element being configured to engage the workpiece, and wherein the gripping mechanism is positioned between the lever arm and the drive element.

8. The wrench of claim 7, wherein the gripping mechanism includes a pin providing the end, the pin being supported by the drive element.

9. The wrench of claim 8, wherein the drive element is driven for rotation, and wherein the pin is supported for movement with the drive element about the axis, the pin moving between the first position and the second position during movement about the axis.

10. The wrench of claim 8, wherein the gripping mechanism includes a plurality of pins, each of the plurality of pins being supported by the drive element and providing an end selectively engageable with the workpiece, each of the plurality of pins being movable between a first position, in which the end engages a surface of the workpiece to retain the workpiece relative to the drive element, and a second position, in which the end is disengaged from the workpiece.

11. The wrench of claim 8, wherein the gripping mechanism includes a ring supported by the drive element, the pin being supported by the ring.

12. The wrench of claim 11, wherein the gripping member includes an actuating mechanism configured to move the ring relative to the drive element to cause the pin to move from the second position toward the first position.

13. The wrench of claim 12, wherein the actuating mechanism includes a belt positioned about a periphery of the ring, and
an actuator operable to cause the belt to move the ring relative to the drive element.

14. A hydraulic torque wrench operable to apply torque to a workpiece, the wrench comprising:
a housing;
a drive system;
a driver driven by the drive system and configured to engage the workpiece; and
a gripping mechanism operable to selectively retain the workpiece relative to the driver, the gripping mechanism being coupled to the driver and including a pin having an end selectively engageable with the workpiece, the pin being movable between a first position, in which the end engages a surface of the workpiece to retain the workpiece relative to the driver, and a second position, in which the end is disengaged from the workpiece.

15. The wrench of claim 14, wherein the driver is rotatable about an axis, and wherein the pin is supported for movement about the axis, the pin moving between the first position and the second position during movement about the axis.

16. The wrench of claim 14, wherein the gripping mechanism includes a plurality of pins, each of the plurality of pins providing an end selectively engageable with the workpiece, each of the plurality of pins being movable between a first position, in which the end engages a surface of the workpiece to retain the workpiece relative to the driver, and a second position, in which the end is disengaged from the workpiece.

17. The wrench of claim 16, wherein each of the plurality of pins is supported for movement about the axis, each of the plurality of pins moving between the first position and the second position during movement about the axis.

18. The wrench of claim 14, wherein the gripping mechanism includes a spring operable to bias the pin toward the second position.

19. The wrench of claim 14, wherein the driver includes a lever arm and a drive element configured to engage the workpiece, and wherein the gripping mechanism is positioned between the lever arm and the drive element.

20. The wrench of claim 14, wherein the gripping mechanism includes a ring supported by the drive element, the pin being supported by the ring.

21. The wrench of claim 20, wherein the gripping member includes an actuating mechanism configured to move the ring relative to the drive element to cause the pin to move from the second position toward the first position.

22. The wrench of claim 21, wherein the actuating mechanism includes
a belt positioned about a periphery of the ring, and
an actuator operable to cause the belt to move the ring relative to the drive element.

23. A method of operating a hydraulic torque wrench operable to apply torque to a workpiece, the wrench including a housing, a drive system, and a driver rotatably driven by the drive system and configured to selectively engage the workpiece, the method comprising:
selectively engaging an end of a gripping mechanism with the workpiece, selectively engaging including moving the gripping mechanism between a first position, in which the end engages a surface of the workpiece to retain the workpiece relative to the driver, and a second position, in which the end is disengaged from the workpiece.

24. The method of claim 23, wherein the gripping mechanism includes a pin providing the end, and wherein selectively engaging includes selectively engaging the end of the pin with the workpiece, selectively engaging including moving the pin between the first position and the second position.

25 - 31. (canceled)

32. A method of operating a hydraulic torque wrench operable to apply torque to a workpiece, the wrench including a housing, a drive system, and a driver rotatably driven by the drive system and configured to selectively engage the workpiece, the method comprising:
selectively engaging an end of a pin of a gripping mechanism with the workpiece, selectively engaging including moving the pin between a first position, in which the end engages a surface of the workpiece to retain the workpiece relative to the driver, and a second position, in which the end is disengaged from the workpiece.

33 - 36. (canceled)

37. The method of claim 32, wherein the gripping mechanism includes a plurality of pins, each of the plurality of pins providing an end, and wherein selectively engaging includes selectively engaging the end of each of the plurality pins with the workpiece, selectively engaging including moving each of the plurality of pins between the first position and the second position.

38. (canceled)

39. The method of claim 32, further comprising biasing the pin toward the second position.
